(19) United States
(12) Patent Application Publication
(10) Pub. No.: US 2013/0248300 A1
(43) Pub. Date: Sep. 26, 2013

(54) ELEVATOR SYSTEM

(71) Applicants: Niko RUSANEN, Helsinki (FI); Rauno HATAKKA, Riihimaki (FI)

(72) Inventors: Niko RUSANEN, Helsinki (FI); Rauno HATAKKA, Riihimaki (FI)

(73) Assignee: KONE CORPORATION, Helsinki (FI)

(21) Appl. No.: 13/875,801

(22) Filed: May 2, 2013

Related U.S. Application Data
(63) Continuation of application No. PCT/FI2011/050955, filed on Oct. 31, 2011.

(30) Foreign Application Priority Data
Nov. 3, 2010 (FI) 20106153

(51) Int. Cl. B66B 1/46

(52) U.S. Cl. CPC B66B 1/468
USPC 187/389

(57) ABSTRACT

The present invention discloses a solution for generating automatic elevator calls in an elevator system (10) using a personal identifier (11). According to the invention the identification data of an identifier is read on a first departure floor, information about the departure floor is connected to the identification data, the identification data is read on some second departure floor, and on the basis of the identification data an elevator call for taking the passenger back to the first departure floor is generated.

### FIELD OF THE INVENTION

The invention relates to elevator systems. More particularly the invention relates to a method and to an elevator system for generating automatic elevator calls using a personal identifier.

### BACKGROUND OF THE INVENTION

With regard to elevator systems, call-giving solutions are known in which a passenger can give a destination call to the elevator system by means of an identifier, e.g. by means of an RFID identifier (Radio Frequency Identifier) in his/her possession. The elevator system must in this case be provided with reader units, which read the data contained in the identifier (so-called identification data) and transmit it to the elevator system. On the basis of the identification data the elevator system determines the destination floor specific to a passenger and allocates from the elevator system an elevator car for traveling to the floor in question. The destination floor is typically the floor to which a passenger repeatedly travels, e.g. the floor on which his/her work point is situated. Often access control is also connected to said prior-art solutions such that for each passenger, information about those destination floors in the building, and about other spaces belonging to the access control area and to which the passenger has an access right, is saved in the elevator system or in a special access control system.

A number of drawbacks are, however, connected to the prior-art call-giving solutions described above. The personal information to be connected to the identifier of a passenger, such as said destination floors to be connected to automatic calls, must be manually configured into the elevator system or into an access control system in connection with the elevator system. Configuration is generally performed by the system administrator, which increases the maintenance costs of the system and in general hampers the flexible use of identifiers for giving elevator calls. Prior-art solutions are also poorly applicable to cases in which a passenger must regularly use a number of different elevator systems, which can even be in different buildings.

### AIM OF THE INVENTION

The aim of the present invention is to eliminate or at least to alleviate said drawbacks that occur in prior-art solutions. The aim of the invention is also to achieve one or more of the following objectives:
a self-learning system, which automatically registers and repeats the elevator journeys made by passengers,
to facilitate and speed up travel in elevator systems,
a simple and cost-effective elevator system for generating automatic elevator calls,
a call-giving solution, which is suited for use in a number of elevator systems that are separate from each other.

### SUMMARY OF THE INVENTION

The method according to the invention is characterized by what is presented in the characterization part of claim 1. The elevator system according to the invention is characterized by what is presented in the characterization part of claim 7. Other embodiments of the invention are characterized by what is presented in the other claims. Some inventive embodiments are also presented in the descriptive section and in the drawings of the present application. The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. The features of the various embodiments of the invention can be applied within the scope of the basic inventive concept in conjunction with other embodiments.

The present invention discloses a method for generating automatic elevator calls in an elevator system by means of personal identifiers given into the possession of passengers. In the method the identification data contained in an identifier is read on the first departure floor of a passenger, information about said first departure floor is connected to the identification data, the identification data is read on some second departure floor to which the passenger has transferred from the first departure floor, and an automatic elevator call for taking the passenger from said second departure floor to said first departure floor is generated. The term departure floor refers in this context to the floor on which the identifier of a passenger is read and from which he/she can travel with the elevator to the destination floor that he/she wants. The term elevator call refers to any call whatsoever given to an elevator system. The identifier given into the possession of a passenger is e.g. a remotely-readable RFID identifier or some other personal identifier suited to the purpose. For reading the identification data contained in an identifier, the elevator lobbies and/or the elevator cars and/or the call-giving devices (call panels) of the elevator system are provided with suitable reader units.

The basic concept of the invention is that an elevator system, or a system in connection with it, saves the departure floor of a passenger before each elevator journey and automatically generates an elevator call for taking the passenger from the current floor to the departure floor of the previous elevator journey. In the method according to the invention a passenger gives at the beginning of a first elevator journey a manual elevator call to the destination floor he/she wants and when he/she leaves from the destination floor in question and comes to the elevator lobby of a floor, the elevator system automatically generates an elevator call for taking the passenger from the floor in question to the departure floor of the previous elevator journey. The elevator system is therefore a self-learning system and does not need configuration of the data for the destination floors of a passenger, or other corresponding data, by the administrator of the elevator system. As a result of this self-learning capacity, a passenger can without difficulty use the same personal identifier in a number of different buildings having elevator systems in which the solution according to the invention is applied.

In one embodiment of the invention the classification data given by a passenger in connection with a manual elevator call is registered, which classification data is connected to automatic elevator calls to be generated later for the passenger. The classification data indicates that a passenger belongs to some special group, e.g. that he/she is physically handicapped. As a result of the embodiment, the elevator system automatically learns and takes into account the special needs of a passenger in the elevator service.

In one embodiment of the invention the elevator journeys made by a passenger during a visit are saved, on the basis of which elevator journeys automatic elevator calls are generated during the following visit. As a result of the embodiment, a passenger can easily save e.g. the elevator journeys made during his/her workdays and repeat the same elevator journeys automatically when going to the building on the following workday.

In one embodiment of the invention the elevator system is provided with at least one movement detector, with which the arrival of passengers in an elevator lobby (at the departure floor) is detected. On the basis of the identification signal of the movement detector, an automatic landing call is generated for getting an elevator car to the floor in question. After the passenger has transferred from the elevator lobby into the elevator car serving him/her, the reader unit in the elevator car reads the identification data contained in the identifier of the passenger, on the basis of which identification data an automatic elevator call to the departure floor of the previous elevator journey can be generated.

The present invention also discloses an elevator system for generating automatic elevator calls. The elevator system comprises at least one elevator, a control system controlling the elevator system, and also call-giving devices for registering manual elevator calls. The elevator system further comprises a back-end system in connection with said control system, and also at least one reader unit for reading the identification data contained in the identifiers given into the possession of passengers. The elevator system is arranged to read the identification data contained in an identifier of a passenger on the first departure floor of the passenger, to connect the information about said first departure floor to said identification data, to read the identification data of the identifier on the second departure floor of the passenger, and to generate an automatic elevator call for taking the passenger from the second departure floor to the first departure floor on the basis of said identification data.

With the solution according to the invention numerous advantages are achieved compared to prior-art solutions. The elevator system according to the invention is a self-learning system and does not require personnel resources for configuring or updating passenger-specific data, in which case the elevator system becomes simple and maintenance work is minimized. The teaching of elevator journeys is based on predicting elevator journeys made by the passenger himself/herself, making the system easy to use and flexibly applicable for use even in elevator systems located different buildings. In this context, reference is also made to the other advantages to be achieved with the invention, which are presented above in connection with the different embodiments.

### LIST OF FIGURES

In the following, the invention will be described in detail by the aid of examples of its embodiments, wherein:

FIG. 1 presents one elevator system according to the invention.

### DETAILED DESCRIPTION OF THE INVENTION

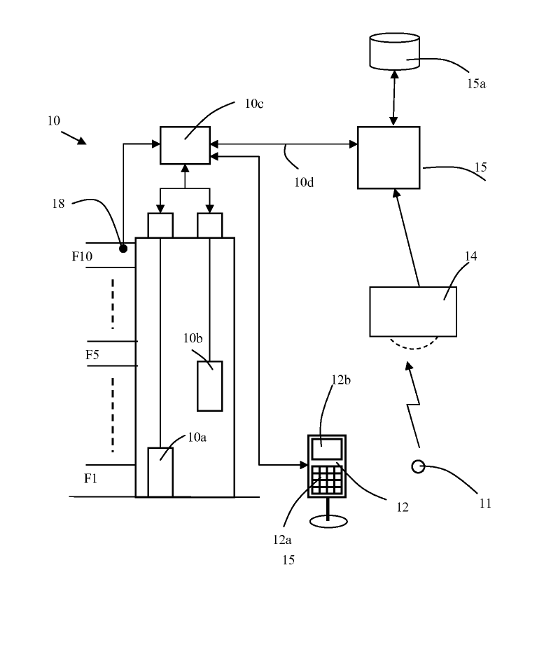

FIG. 1 presents one elevator system 10 according to the invention, which comprises the elevators 10a and 10b of the elevator system 10, a control system 10c of the elevator system, a back-end system 15 connected to the control system 10c, and also call-giving devices 12 in the elevator lobbies and/or in the elevator cars for registering manual elevator calls. An identifier 11 is given for the personal use of a passenger, which identifier is e.g. a remotely-readable RFID identifier and the identification data contained by which identifier can be read by reader units 14 in the elevator lobbies (in FIG. 1 only the reader unit of the entrance lobby floor F1 is presented). The identification data contain e.g. the individual ID number of the identifier, which ID number the reader unit 14 reads and transmits to the back-end system 15. Alternatively, the reader units can be disposed in the elevator cars, instead of in the elevator lobbies, in which case either a passenger must give a manual elevator call in the elevator lobby, or the elevator lobbies must be provided with optical or other corresponding movement detectors for calling an elevator car to the floor level when a passenger arrives in an elevator lobby to wait for an elevator. In FIG. 1 a movement detector on the topmost floor F10 is presented with the reference number 18 by way of example, which movement detector detects passengers arriving in the elevator lobby of floor F10 and sends the detection data to the control system 10c for ordering an elevator car to the floor F10. After an elevator car has arrived at the floor F10 and the passenger moves into the elevator car, the reader unit in the elevator car reads the ID number of the identifier of the passenger, on the basis of which ID number the elevator system generates an automatic destination call if the passenger does not give a manual destination call with the call pushbuttons in the elevator car.

Destination call panels and/or conventional up/down pushbuttons in the elevator lobbies can be used as call-giving devices 12. FIG. 1 presents only the destination call panel 12 disposed on the floor F1 (the entrance lobby floor), which destination call panel comprises call pushbuttons 12a for registering a manual destination floor call, as well as a display unit 12b for indicating the elevator serving the call to the passenger who gave the call. In addition to call pushbuttons 12a, a destination call panel comprises a classification pushbutton 12aa, with which a physically handicapped passenger can order handicapped-accessible transport for himself/herself. Elevators serving automatic elevator calls can also be indicated with a display unit 12b and/or the elevator lobbies can be provided with signs (not presented in FIG. 1) for indicating the serving elevators. It is also possible to provide identifiers 11 with a display unit, to which the elevator system transmits information about the elevator serving a passenger.

The back-end system 15 comprises a processing unit, software and also a memory means 15a for saving information connected to automatic elevator calls. The back-end system is connected via a data transfer connection 10d to the control system 10c for sending automatic elevator calls from the back-end system to the control system and also, if necessary, for transmitting the status information of the elevators from the control system to the back-end system.

When the holder of an identifier 11 (a passenger) arrives in the entrance lobby F1 of a building for the first time, he/she goes to a call-giving device 12 and gives a manual destination call e.g. to floor F5. In the same connection, the reader unit 14 in the entrance lobby reads the ID number of the identifier and transmits it to the back-end system 15. The back-end system 15 receives the ID number, opens in the memory means 15a the data record corresponding to the ID number and saves in the data record information about the departure floor of the passenger, which in this example case is the entrance lobby F1. The control system 10c allocates to the passenger an elevator car, which takes him/her from the entrance lobby floor F1 to the floor F5. After arriving at floor F5 the passenger moves e.g. into his/her office. When the passenger returns back to the elevator lobby of floor F5, the reader unit 14 in the elevator lobby of floor F5 detects the identifier 11 of the passenger, reads the ID number contained in said identifier and transmits the ID number to the back-end system 15. The back-end system, on the basis of ID number, identifies the data record, which comprises information about the departure floor of the previous elevator journey of the passenger and generates an automatic destination call from floor F5 to the departure floor in question, which in this example case is the entrance lobby floor F1. In the same connection, the back-end system updates the new departure floor (floor F5) in the data record for the following elevator journey. When the passenger e.g. on the following morning arrives in the entrance lobby F1 of the building, the back-end system generates in the manner described above an automatic destination call from the entrance lobby floor F1 to the floor F5. If a passenger has, in connection with a manual call, pressed the classification pushbutton 12aa, this is taken into account also when generating automatic calls by ordering for the passenger elevator transport according to the classification, e.g. by lengthening the door times of the doors of the elevator for a physically handicapped passenger.

In the preceding example, the elevator lobbies contain reader units 14, which read the identification data contained in the identifiers 11 of passengers in the elevator lobbies. Since the back-end system 15 has the position data of the reader units available for its use, the back-end system can detect the elevator lobby of which floor at which a passenger arrives at any given time (by elevator or by walking) or from the elevator lobby of which floor a passenger leaves (by elevator or by walking). By means of the reader units the departure floor, on which floor the passenger moves into the elevator car, as well as the destination floor, where he/she leaves the elevator car, of an elevator journey performed by a passenger can thus be determined. A corresponding determination can be performed with the reader units in the elevator cars by detecting with a reader unit the presence of the identifiers of passengers in the elevator car and by identifying the floor at which the elevator car is located at the time of the detection.

According to one embodiment of the invention the back-end system 15 registers the elevator journeys made by a passenger during one visit. The term visit refers to the period of time from the moment a passenger arrives in a building to the moment he/she leaves the building. The embodiment comprises a type of “recording function”, wherein the elevator journeys made by a passenger during one visit are saved in the memory means 15a, in the sequence in which they are performed, including information about the departure floor and destination floor of each elevator journey. In the example according to FIG. 1, the “recording function” starts when a passenger arrives at the entrance lobby floor F1 and the reader unit 14 on the entrance lobby floor F1 detects the identifier 11 of the passenger. The “recording function” ends in the example case according to FIG. 1 when the reader unit 14 on the entrance lobby floor F1 detects a passenger (identifier 11) leaving the detection area of the reader unit 14 in the entrance lobby F1 and the identifier 11 of the passenger is not detected after this with any reader unit 14 during a preset period of time. When the passenger visits the building on a following occasion and his/her identifier 11 is detected in the elevator lobbies of different floors, the back-end system generates automatic elevator calls on the basis of the elevator journeys saved in the memory means 15a taking into account the sequence of saving the elevator journeys for specific floors. If the passenger does not make an elevator journey according to said automatic elevator call (e.g. he/she does not step into the elevator car allocated to him/her), the back-end system deletes the elevator journey in question from the plurality of saved elevator journeys. Correspondingly, if a passenger gives a manual elevator call and makes an elevator journey, of which a “recording” has not been made, the back-end system adds the elevator journey in question to the plurality of saved elevator journeys.

The invention is not only limited to be applied to the embodiments described above, but instead many variations are possible within the scope of the inventive concept defined by the claims. Thus, for example, the back-end system presented in FIG. 1 as a separate computer system can be either fully or partly integrated into the control system 10c. Also the memory means 15a, as an exception to FIG. 1, can be integrated either fully or partly into the control system 10c and/or into the identifiers 11, and the reader units 14 can be used e.g. for sending data to be saved in the integrated memory means 15a to the identifiers 11.

1. Method for generating automatic elevator calls in an elevator system by means of a personal identifier given into the possession of a passenger, wherein the method comprises the phases:
the identification data contained in said identifier is read on the first departure floor of a passenger;
information about said first departure floor is connected to said identification data;
the identification data contained in the identifier is read on the second departure floor of the passenger; and
on the basis of the identification data an automatic elevator call for taking the passenger from said second departure floor back to said first departure floor is generated;

2. Method according to claim 1, wherein the classification data given by a passenger in connection with a manual elevator call is registered; and said classification data is taken into account when generating said automatic elevator calls.

3. Method according to claim 1, wherein the method comprises the phases: the elevator journeys made by a passenger during a visit are saved; and during the following visit one or more automatic elevator calls are generated on the basis of saved elevator journeys.

4. Method according to claim 1, wherein the identification data contained in the identifier is read when the passenger is in the elevator lobby.

5. Method according to claim 1, wherein the identification data contained in the identifier is read when the passenger is in the elevator car.

6. Method according to claim 1, wherein the arrival of a passenger at a departure floor is detected by means of a movement detector disposed in the elevator lobby of the departure floor; and an automatic landing call is generated for collecting the passenger from said departure floor on the basis of said detection.

7. Elevator system for generating automatic elevator calls, which elevator system comprises at least one elevator, a control system and call-giving devices for registering manual elevator calls, wherein the elevator system further comprises: a back-end system in connection with the control system, at least one reader unit connected to the back-end system for reading the identification data contained in the identifiers given into the possession of passengers, and in that the elevator system is arranged: to read the identification data contained in an identifier on a first departure floor; to connect the information about said first departure floor to said identification data; to read the identification data contained in an identifier on a second departure floor; and to generate an elevator call for taking the passenger from said second departure floor to said first departure floor.

8. Elevator system according to claim 7, wherein the call-giving devices comprise at least one classification pushbutton for registering classification data in connection with a manual elevator call, and in that the elevator system is arranged: to connect said classification data to the identification data; and to take into account said classification data in the generation of automatic elevator calls.

9. Elevator system according to claim 7, wherein the elevator lobbies and/or the elevator cars are provided with reader units for reading the identification data contained in identifiers.

10. Elevator system according to claim 7, wherein the elevator system is arranged: to save the elevator journeys made by a passenger during one visit; and to generate during the following visit one or more automatic elevator calls on the basis of saved elevator journeys.

11. Elevator system according to claim 7, wherein the elevator system comprises a movement detector disposed in at least one elevator lobby for generating an automatic landing call after a passenger has reached said elevator lobby.
